(19) United States
(12) Patent Application Publication
(10) Pub. No.: US 2021/0146591 A1
(43) Pub. Date: May 20, 2021

(54) MANUFACTURING METHOD OF SHEET FOR FOOD CONTAINERS AND SHEET FOR FOOD CONTAINERS MANUFACTURED BY USING THE SAME

(71) Applicant: D & D BEST ONE CORPORATION, Chicago, IL (US)

(72) Inventor: Young Taik WOO, Gyeonggi-do (KR)

(21) Appl. No.: 16/688,473

(22) Filed: Nov. 19, 2019

(51) Int. Cl. B29C 48/88; B65D 1/34; B29C 48/08; B05D 3/14

(52) U.S. Cl. CPC B29C 48/9135; B65D 1/34; B29K 2067/046; B05D 3/144; B29C 48/08

(57) ABSTRACT

A manufacturing method of a sheet for food containers and a sheet for food containers manufactured by using the same, the method comprising: step 1 of blending a poly L-lactide (polylactic acid: PLA) and a polybutylene succinate (PBS) resin with a base material, and adding an organically treated organic cloisite; step 2 of melt-mixing the resin composition obtained in step 1 at high temperature by using an extruder, followed by quenching with cold water to be flattened; and step 3 of drying a flat plate-shaped resin obtained in step 2 by using a hot air dryer.

### BACKGROUND

The present invention relates to a manufacturing method of sheet for food containers and a sheet for food containers manufactured by using the same.

In general, paper materials that are laminated or resin-coated on the surface of papers have been conventionally used in various fields. For some examples that are commonly used for residential buildings, papers are used for the paper sliding door as a partition for the opening and closing of a Japanese-style room, for example, a rayon sling door paper which is made by mixing rayon or polypropylene at a predetermined ratio, a sling door paper which is laminated with a plastic film on the rayon paper, and a sling door paper which is laminated with acrylic material or vinyl chloride material on the surface of a Japanese paper.

In addition to the paper, it is generally known that a sheet material such as a plastic sheet or a vinyl sheet is high in light transmittance and excellent in water repellency.

Conventionally, polyvinylidene chloride (PVDC) was widely used as a film or a sheet for food packaging because of its excellent oxygen barrier property.

As food containers, for example, foamed polystyrene was used for containers for cup noodles and the like and an elongated transparent container of polypropylene resin was used for containers for microwave cooking foods.

Since conventional paper materials, except for paraffin paper or cellophane paper and the like, do not have light transmittance, there is a problem that these paper materials cannot be used for a product requiring light transparency. Moreover, the conventional paper materials are usually high in hygroscopic property and are not sufficient even in terms of strength.

Although the rayon sliding door paper and the like can solve such a problem to some extent, since it is easy to generate static electricity, there is a new problem that the dust is prone to stick. Moreover, although the material itself is relatively resistant to water, there is also a problem that an adhesive surface is easily peeled off by inhaling moisture when cleaned with a wet mop or the like.

Prior Art Document: Korean Patent Registration No. 10-0710107

### SUMMARY OF THE INVENTION

The present invention has been made to solve the problems of the prior art, and it is an object of the present invention to provide a manufacturing method of a sheet for food containers which is high strength, heat resistant, and emits far infrared rays so that it can safely preserve food for a long time, and at the same time allows the packaged food to be antioxidant, antibacterial, and biodegradable, and a sheet for food containers manufactured by using the same.

The object of the present invention described above can be achieved by the manufacturing method of a sheet for food containers including: step 1 of blending a poly L-lactide (polylactic acid: PLA) and a polybutylene succinate (PBS) resin with a base material, and adding an organically treated organic cloisite; step 2 of melt-mixing the resin composition obtained in step 1 at high temperature by using an extruder, followed by quenching with cold water to pelletize; and step 3 of drying a pellet-type resin obtained in step 2 using a hot air dryer.

According to the present invention, it is possible to prevent environmental pollution by using a L-lactide (polylactic acid: PLA) and a polybutylene succinate (PBS) resin of biodegradable polymer as a base material and improve the mechanical strength characteristics through an organic cloisite, and at the same time, far infrared rays are released by one or two selected from the group consisting of pozzolanic, tourmaline, gellite, sericite, and germanium, so that the food container can have excellent durability, extend the shelf life of the food by the deodorizing and sterilizing function, and cook the food by heating it with a microwave oven in the packaged state, thereby having the effect of increasing the convenience of consumers such as making the food easy to eat.

### BRIEF DESCRIPTION OF DRAWINGS

FIG. 1 is a flow chart showing a manufacturing method of a sheet for food containers according to a first embodiment of the present invention.

FIG. 2 is a flow chart showing a manufacturing method of a sheet for food containers according to a second embodiment of the present invention.

FIG. 3 is a view showing the food container using a sheet for food containers according to the present invention.

### DETAILED DESCRIPTION OF THE INVENTION

Hereinafter, preferred embodiments of the present invention will be described in detail with reference to the accompanying drawings.

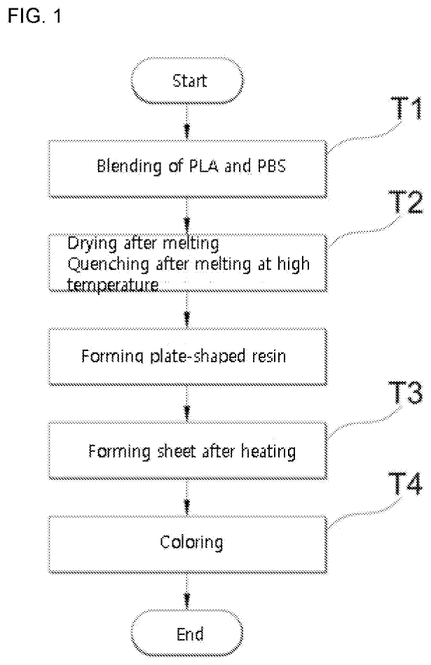

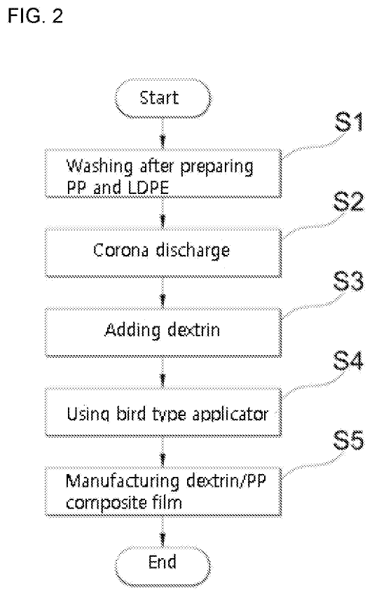

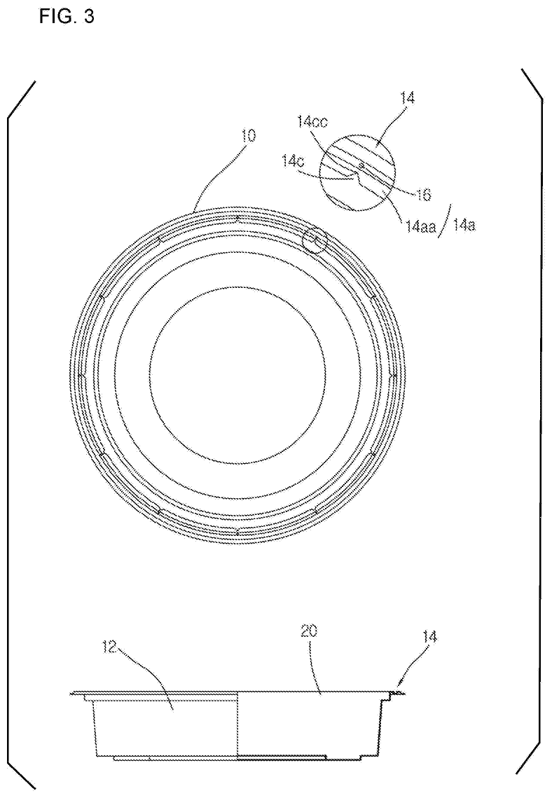

In the drawings, FIG. 1 is a flow chart showing a manufacturing method of a sheet for food containers according to a first embodiment of the present invention; FIG. 2 is a flow chart showing a manufacturing method of a sheet for food containers according to a second embodiment of the present invention; and FIG. 3 is a view showing the food container using a sheet for food containers according to the present invention.

Referring to FIG. 3, a container for food packaging applied to the present invention includes a main body 10 and a film cover 20 for sealing the main body.

In the main body 10, a concave receiving portion 12 which can accommodate foods and fresh foods is formed and an outer peripheral surface 14, extended horizontally from the place where the receiving portion 12 is finished, is integrally formed and finished.

The outer peripheral surface 14 is finished with a horizontal plane where the film cover 20 is fused.

Specifically, the outer peripheral surface 14 is formed with a double convex fusion portion 14a, and the fusion portion 14a is a place where the film cover 20 is fused.

Since the fusion portion 14a is formed in double with a gap, a through-hole 16 is formed between the gaps.

In particular, a plurality of vapor discharge grooves 14c are formed as a first fusion portion 14aa close to the receiving portion 12 of the fusion portion 14a.

The vapor discharge groove 14c is formed in a triangular shape as an example, but is not limited to the shape, and preferably an edge 14cc is sharpened as it is closer to the gap.

In particular, the edge 14cc is preferably finished with a gap between 0.5 to 5 mm of the first fusion portion 14aa.

The main body 10 formed as described above is used to fuse the film cover 20 after accommodating the contents such as foodstuffs in the receiving portion 12, especially may be processed and used by a microwave oven.

In this case, the receiving portion 12 is filled with gas depending on the foodstuff of the receiving portion 12, and the internal pressure reaches a predetermined threshold with the lapse of heating and time.

The fusion unit 14a applied to the present invention serves to release the pressure reaching the threshold and discharge the vapor at the same time as the fusion of the film cover 20.

The edge 14cc of the vapor discharge groove 14c formed in the first fusion portion 14aa is for discharging the vapor having reached a predetermined pressure, and the fusion with the film cover 20 is separated by the pressure from a narrow gap between the edge 14cc and the first fusion portion 14aa, the vapor is discharged to the separated space, and the discharged vapor is discharged to the outside through the through hole 16 again.

For the main body 10 and the film cover 20 formed as described above, a conventional plastic is not applied because it takes a long time to be decomposed and it is recognized as a material having a negative image for the reason that the component harmful to the environment is generated.

Generally, a common method for improving the mechanical-physical properties of plastics is to reinforce general purpose plastics with inorganic additives.

The inorganic additives have advantages of being inexpensive and easily improvable their physical properties. However, there are disadvantages that since the inorganic additives remain in the solid phase during the processing process and are very hard, the processing equipment is worn and the interface adhesive force with a molten polymer is poor, so that the viscosity of the molten polymer is increased and compounding is difficult. A method to improve these disadvantages is to prepare a nanocomposite.

The manufacturing technology of nanocomposite generally disperses the particles of an inorganic reinforcing agent to a polymer matrix to a nano size, so that polymer nanocomposites can achieve the improvement of superior physical properties compared to the existing composites.

This technology can obtain better physical properties even when using a smaller amount of inorganic additives than a conventional inorganic additive reinforcement composite material, and can maximize the mechanical-physical properties by dispersing the reinforcing agent to a nano size.

Referring to FIG. 1, a manufacturing method of a sheet for food containers which forms the main body of the present invention is described.

[Step 1 (T1)]

Polylactic acid (polylactic acid: PLA) and polybutylene succinate (PBS) resin, known as biodegradable polymer, are blended with a base material and an organic cloisite, organically treated, is added thereto.

[Step 2 (T2)]

PLA and cloisite are prepared in a molten state under a nitrogen atmosphere, dried at 70° C. for 8 hours using a hot air dryer, melt-mixed at high temperatures of 220 to 240° C. using an extruder, and then quenched with cold water to obtain a sheet resin in a flat plate shape.

In this case, when PLA is 100 parts by weight, cloisite of 0.5 to 5 parts by weight is used.

[Step 3 (T3)]

The plate-shaped resin obtained in step 2 (T2) is dried again at 70 to 80° C. for 7 to 9 hours using a hot air dryer to manufacture a sheet.

Specifically, the sheet is manufactured by drying at 70° C. for 8 hours.

Thereafter, the sheet is put in a molding machine to mold the main body 10.

[Step 4 (T4)]

A colorant is applied to color the main body 10.

The colorant necessary for color realization is used as a pigment extracted from nature, and lacquer, charcoal, and ocher, which are nature ingredients beneficial to humans such as antibacterial and far-infrared rays, are used.

Coloring is achieved only through the melting process, and a plastic colorant should be clear in color and should not be toxic as well as having excellent coloring power, dispersibility, solvent resistance, migration resistance, heat resistance, weather resistance, chemical resistance, electrical properties, friction resistance, and emulsion resistance. Therefore, in the present invention, when PLA is 100 parts by weight, each input content of refined powder-type plastic colorants extracted from charcoal, lacquer, and ocher is used with 1 to 5 parts by weight.

Meanwhile, the present invention includes a sheet for food containers used as a film cover 20 fused with the main body 10 to seal the main body 10.

Referring to FIG. 2, a specific manufacturing method of a sheet for food containers used as this film cover 20 is described.

[Step 1 (S1)]

A polypropylene (PP) with a thickness of 48.7±0.6 μm and a low density polyethylene (LDPE) film with a thickness of 53.7±0.9 μm are manufactured.

The PP or LDPE film is washed with acetone and distilled water and then dried to remove impurities on the surface before use.

[Step 2 (S2)]

The surface energy is increased by performing a corona discharge treatment on the surface of a base film using a corona treater on the condition of 25 to 30 kv/cm and 4 to 5 MH.

[Step 3 (S3)]

In the case of dextrin, which is a decomposition product of corn starch, an appropriate amount of plasticizer is added in an aqueous solution of 7 to 45% (w/v) and heated at 95° C. for 25 minutes, and then a predetermined amount of the dextrin solution is added on a corona discharge-pretreated PP film or LDPE film while keeping warm at 55r.

[Step 4 (S4)]

Dextrin is applied evenly to the surface using a bird applicator with a gap of 0.305 mm and naturally dried at room temperature for two days to prepare a dextrin/PP composite film.

In this case, if the concentration of applied dextrin was lower than 25% (w/v), the viscosity of the solution was too low to cast a film. If glycerol is added as a plasticizer, since a molded dextrin film layer is fragile at a concentration below 25% (w/w, weight ratio 4:1), if 30% glycerol is added in an aqueous dextrin solution of 25 to 45% and other plasticizer is used, a reference condition is set to be added by adjusting the solution to the same mole concentration (1.14M).

[Step 5 (S5)]

Chitosan, a multivalent cationic biopolymer, is dissolved in 2% (v/v) aqueous acetic acid solution at the concentration of 0.75 to 1.50% (w/v), a 100% (w/w, weight ratio 1:1) glycerol or a plasticizer corresponding to 0.109M is added, and then foams are removed to prepare a chitosan coating solution.

[Step 6 (S6)]

A predetermined amount of polysaccharide biopolymer coating solution is added and applied evenly on the surface of a corona discharge-pretreated PP film or LDPE film using a bird type applicator, and then naturally dried at room temperature for 2 days to complete the film cover 20.

The present invention is not limited to the above-described embodiments and the accompanying drawings, and various modifications and applications which are not exemplified can be made in the scope without departing from the technical idea of the present invention, as well as substitution of components and modification to other equivalent embodiments. Therefore, the contents related to modifications and applications of the features of the present invention should be construed as being included within the scope of the present invention.

What is claimed is:

1. A manufacturing method of a sheet for food containers, which forms a main body, the method comprising:
step 1 of blending a poly L-lactide (polylactic acid: PLA) and a polybutylene succinate (PBS) resin with a base material, and adding an organically treated organic cloisite;
step 2 of melt-mixing a resin composition obtained in step 1 at high temperature by using an extruder, followed by quenching with cold water to be flattened; and
step 3 of drying a flat plate-shaped resin obtained in step 2 by using a hot air dryer.

2. The manufacturing method of a sheet for food containers according to claim 1, further comprising step 4 of coloring the plate-shaped resin by using a colorant, wherein the colorant is a type of refined powder extracted from charcoal, lacquer, and ocher, and each input content thereof is used by mixing 1 to 5 parts by weight when PLA is 100 parts by weight.

3. The manufacturing method of a sheet for food containers according to claim 1, wherein when PLA is 100 parts by weight, cloisite of 0.5 to 5 parts by weight is mixed.

4. The manufacturing method of a sheet for food containers according to claim 1, wherein in the step 3, a plate-shaped resin is dried at 70 to 80° C. for 7 to 9 hours by using a hot air dryer.

5. A sheet for food containers manufactured by the manufacturing method described in claim 1.

6. A manufacturing method of a sheet for food containers, which is used as a film cover fused with the main body, the method comprising:
step S1 of preparing a polypropylene (PP) and a low density polyethylene (LDPE) film;
step S2 of increasing a surface energy by performing a corona discharge treatment on the surface of a base film by using a corona treater;
step S3 of adding a plasticizer in an aqueous dextrin solution and heating it, and then adding the solution on a corona discharge-pretreated PP film or LDPE film while keeping warm; and
step S4 of applying the solution evenly on the surface using a bird type applicator and drying it to prepare a dextrin/PP composite film.

7. The manufacturing method of a sheet for food containers according to claim 6, wherein in the step S1, a polypropylene (PP) has a thickness of 48.7±0.6 μm and a low density polyethylene (LDPE) film has a thickness of 53.7±0.9 μm.

8. The manufacturing method of a sheet for food containers according to claim 6, wherein in the step S2, a corona discharge treatment is performed on the condition of 25 to 30 kv/cm and 4 to 5 MH.

9. The manufacturing method of a sheet for food containers according to claim 6, wherein in the step S3, an aqueous solution of 7 to 45% (w/v) is used for dextrin, which is a decomposition product of corn starch.

10. The manufacturing method of a sheet for food containers according to claim 6, wherein in the step S3, 30% glycerol is added to an aqueous dextrin solution of 25 to 45%.

11. The manufacturing method of a sheet for food containers according to claim 10, wherein in the step S4, dextrin is naturally dried at room temperature for two days using a bird applicator with a gap of 0.305 mm.

12. A sheet for food containers manufactured by a manufacturing method described in claim 6.
